(19) United States
(12) Patent Application Publication
(10) Pub. No.: US 2008/0258887 A1
(43) Pub. Date: Oct. 23, 2008

(54) Device for the Detection of a Collision of a Motor Vehicle

(75) Inventors: Serdar Gelberi, Pliezhausen (DE); Bernd Grundner, Reichenbach (DE); Carsten Lorenz, Grafenau-Doeffingen (DE); Michael Meyer, Altdorf (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 11/793,493

(22) PCT Filed: Dec. 13, 2005
(86) PCT No.: PCT/EP2005/013352

§ 371 Date: May 21, 2008

(30) Foreign Application Priority Data
Dec. 24, 2004 (DE) 10 2004 062 484.4

(51) Int. Cl. B60Q 11/00

(52) U.S. Cl. 340/436

(57) ABSTRACT

A device for the detection of a collision of a motor vehicle has at least one collision sensor which is arranged between the vehicle or fender outer skin and the vehicle body part, and senses an impact of an object on the motor vehicle. The collision sensor comprises a compressible spacer.

This application is a national stage of PCT International Application No. PCT/EP2005/013352, filed Dec. 13, 2005, which claims priority under 35 U.S.C. § 119 to German Patent Application No. 10 2004 062 484.4, filed Dec. 24, 2004, the disclosure of which is expressly incorporated by reference herein.

### BACKGROUND AND SUMMARY OF THE DISCLOSURE

The invention relates to a vehicle collision detection device having at least one collision sensor arranged between the vehicle or fender outer skin and a vehicle body part.

Modern motor vehicles include, numerous safety devices which reduce the severity of an accident for those involved in it. Early detection of an accident situation is particularly important so that the safety devices which are appropriate for the given accident conditions can be activated in as short a reaction time as possible.

Sensors which operate in accordance with different measurement principles are used in practice to detect a head-on impact, a side impact or a rear-end impact.

Force-measuring sensors (for example force-sensitive resistors), which are widely used are provided, for example, in a fender of the motor vehicle in such a manner that force is applied to them in the event of contact between the fender and a collision object or in the event of deformation of the fender.

Such a sensor system is disclosed, for example, in European patent document EP 0 518 381 B1. It is intended to detect a collision of the vehicle, and has a multiplicity of primary sensors for individually emitting signals when compressed as a result of a collision of the vehicle as well as a secondary sensor for outputting a signal after the primary sensors if the secondary sensor is compressed as a result of a collision.

German patent document DE 43 25 414 C2 discloses the use of resistive membrane-type pressure sensors for detecting an impact. In such sensors, an electrical signal is passed to an evaluation circuit in the event of impact-induced deformation of the outer skin of the vehicle and thus action of a force on the sensors. The evaluation circuit activates safety devices of the vehicle on the basis of the received signal.

European patent document EP 0 848 780 B1 discloses the use of membrane-type pressure sensors in a jamming protection device. The membrane-type pressure sensors are used to detect jamming in a force-actuated closure element, such as a window winder. In this case, the membrane-type pressure sensors are arranged inside an elastic hollow profile (in particular a rubber hollow chamber profile) and extend along a closing edge.

In another known method for detecting a collision between a vehicle and a collision object, deformation of a respective affected fender of the motor vehicle is measured in the event of contact with the collision object. To this end, the change in resistance of an appropriately fitted multisegment strain gauge or the changed light reflection in a multisegment optical waveguide, for example, is used to detect the collision situation.

The use of optical fiber sensors in a pedestrian protection system is disclosed in German patent document DE 102 56 956 A1. In this case, the sensor region is arranged on a foam layer, which is arranged on a carrier, or on an elastic crash box. The crash box provides an elastic deformation behavior, so that detection can be carried out on the basis of the deformation. In both embodiments, the sensor region is provided with a plastic layer that is provided as the outer skin.

Furthermore, the technique of measuring the acceleration of vehicle parts in the event of a vehicle collision is also known. The collision between a motor vehicle and a collision object (for example a pedestrian), results in a significant change in the speed of front parts of the motor vehicle while the front fender is being pushed in. This acceleration can be measured using appropriately fitted acceleration sensors. The difference in speed between two contact elements which are arranged behind one another can be used to determine the type of collision partner, as is described, for example, in German patent document DE 2 212 190.

Furthermore, contact sensors are generally arranged on a fender comprising elastic material, in particular foam, with the result that they are less sensitive to unintentional triggering by a rock fall or small animals. The contact sensor comprises, as sensor elements, two conductor tracks which make contact in the case of pressure. The contact sensor thus acts like a switching element. The disadvantage of this is the significant influence of production-dictated or accident-induced fender tolerances, in particular the distance between the fender outer skin and the fender. When the contact sensor is arranged in a foam-like fender, this may result in problems when identfying the type of impact and the object involved in the impact, taking into account required functional temperature ranges. A soft foam with a high level of sensitivity is thus provided for high temperatures and a hard foam with a lower level of sensitivity is provided for low temperatures. In the case of a simple force sensor, this results in inhomogeneous identification and detection of the impact of an object.

Another sensor which is integrated in a damping device is disclosed, for example, in German patent document DE 20 2004 005 434 U1. In order to homogenize the response behavior and to set the switching threshold of the sensor, the latter is integrated in the damping device with predetermined integration parameters which vary with the installation site.

One object of the present invention is to provide a device for the detection of a collision of a motor vehicle, which has at least one collision sensor, and which makes it possible to accurately detect a collision with a design which is as simple as possible.

This and other objects and advantages are achieved by the collision detection device according to the invention, in which the collision sensor, which is arranged between the vehicle or fender outer skin (referred to below as the outer skin for short) and a vehicle body part comprises a compressible spacer. Such a compressible (for example, resilient) spacer has the advantage that changes in the distance between the outer skin and the vehicle body part, which arise as a result of production tolerances or initial damage to the outer skin, are compensated for in a simple and compressible manner and do not result in an offset of the sensor. The same applies to changes in the distance due to material expansion or contraction caused by environmental influences such as temperature and humidity.

Another advantage of the invention is that the collision sensor is pressed against the outer skin in order to ensure that an impact is detected as accurately as possible in the case of a large air gap or distance between the outer skin and the vehicle body part due to production tolerances or initial damage caused by plastic deformation. As a result, movement and/or deformation of the outer skin is identified in a reliable and sufficiently accurate manner in the event of an impact. Even when there is a small air gap or distance between the outer skin and the vehicle body part, the collision sensor is pressed against the outer skin and makes it possible to reliably detect an impact. A small air gap likewise occurs, for example, as a result of installation and/or production tolerances or else as a result of initial damage to the vehicle or fender outer skin, for example as a result of the vehicle or fender outer skin being dented.

Another advantage of the vehicle collision detection device according to the invention is its insensitivity to stresses in the region of the collision sensor. If, for example when parking, the fender is slowly deformed and the deformation is permanent (for instance, as a result of damage to the fender), the collision sensor remains operational, since it is always pressed against the outer skin, which is relevant to detection and absorbs the collision, by the compressible (for example, resilient) spacer.

In one simple embodiment, the collision sensor comprises a sensor element which is arranged at a distance from the vehicle or fender outer skin on that side of the compressible or resilient spacer which is adjacent to the vehicle or fender outer skin. Positioning the collision sensor directly in the region of the outer skin enables a sufficiently high level of sensor sensitivity. The compressible spacer expediently extends in an essentially longitudinal manner in the direction of impact between the collision sensor and the vehicle body part.

For a configuration of the spacer which can be compressed as effectively as possible, the latter is formed from an elastic rubber element. The spacer is preferably in the form of a hollow profile, in particular a rubber hollow profile. In order to boost the compressibility of the spacer, at least part of the latter has a form which can be compressed in the manner of an accordion or a bellows-like profile. Alternatively, the rubber hollow profile can be formed from a particularly soft rubber curing zone, so that the spacer is accordingly compressible. In another embodiment, the spacer may be formed from a number of cells, in particular rubber cells, which are closed off with respect to one another, can be compressed and are provided with venting and/or ventilating openings. The cells are stacked on top of one another, for example.

In order to fasten the collision sensor, an essentially dimensionally stable (in particular, solid) profile, is provided on that side of the spacer which is remote from the sensor. In order to fasten the sensor to the vehicle body part without being destroyed, the dimensionally stable solid profile is in the form of a clamping element, latching element, clip element, snap-on element and/or sealing element with one or more fastening stages or sealing stages. For example, the dimensionally stable solid profile is used as a fastening foot and has a plurality of fastening stages in the manner of a “fir tree profile” for secure retention.

In order to protect the collision sensor, the latter is arranged in a hollow profile, particularly a rubber-like hollow chamber.

In order to produce the device in as simple and cost-effective a manner as possible, the hollow profile for holding the collision sensor, the resilient spacer and the solid profile in the form of a fastening foot are designed in one piece, in particular in the form of a one-piece rubber profile element. For collision monitoring which is as extensive as possible and, as far as possible, is carried out in regions, the one-piece rubber profile element has an elongate shape which extends, in particular, transversely over the width of the vehicle or longitudinally over the length of the vehicle. An individual elongate sensor element is thus used to monitor regions of the vehicle width or vehicle length or the entire vehicle width or vehicle length for a possible collision. To this end, the sensor element and the rubber profile element are in the form of a rubber band with an integrated sensor element, for example. In this case, the rubber band is held on or in the vehicle body part using the solid profile in the form of a fir tree.

The collision sensor is fastened, for example, by clipping or pressing the fastening foot in the form of a “fir tree profile” into an appropriately shaped and elongate groove of the blocking element (also called impact absorber foam). In this case, the fastening foot is used to press or clip the collision sensor into the groove of the blocking element beginning from one end of the rubber band or the rubber profile element. For removal, the rubber band is levered or pulled out of the groove from one end, so that the collision sensor is removed from the blocking element or is replaced without being destroyed.

As an alternative to the one-piece design of the collision sensor, the hollow profile, the spacer and the solid profile may be separate—in the form of separate individual elements.

The collision sensor comprises a sensor element which is expediently a contact sensor, an acceleration sensor, a force sensor, a fiber-optic sensor and/or a deformation sensor.

Each of these types of sensor can generally be used to detect precisely a collision object such as a pedestrian impact. The device according to the invention is particularly suitable for detecting a pedestrian impact, the at least one collision sensor expediently being a front sensor which is arranged, in particular, in the region of a front fender of the motor vehicle. In this case, a plurality of the collision sensors according to the invention can be arranged such that they are distributed over the width and/or length of the vehicle. In the case of a one-piece design, an individual collision sensor extends, for example, over the entire width of the vehicle, for example over the entire rear side and/or front side, for the purpose of detecting a rear-end collision, or at least partially over the length of the vehicle, for example over the width of a vehicle door, for the purpose of detecting a side impact.

When the device according to the invention is used as a front sensor system, in which the collision sensors are correspondingly applied in the front part of the motor vehicle and it is possible to rapidly detect an impact from the front, the collision sensors are used as externally located “satellites” which, on account of their positioning, enable a more rapid triggering decision by the evaluation and control device than is possible in the case of an airbag controller positioned in the center of a vehicle.

In a manner analogous to its use as a front sensor system. The device according to the invention can also be used to detect a side impact, to this end, sensors are applied in or on doors of the motor vehicle, on a lateral sill or on a door frame.

The device for the detection of a collision of a motor vehicle according to the invention also makes it possible to detect a rear-end impact if at least one collision sensor is fastened to the rear part of the vehicle. In this case, application to the vehicle or fender outer skin is possible by arranging the collision sensor on and/or in a rear fender, on and/or in a trunk flap, the body or a frame part.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic plan view of a motor vehicle having fundamental components of a device according to the invention for the detection of a collision of the motor vehicle;

FIGS. 2 and 3 are schematic sectional illustrations of a front fender and a crossmember of the motor vehicle shown in FIG. 1, with a collision sensor which is arranged between the fender and the crossmember in the region of the vehicle or fender outer skin;

FIG. 4 shows an enlarged detail of FIG. 3 in the region in which the collision sensor is arranged on the vehicle body part; and

FIG. 5 is a simplified sectional view of a fender and a crossmember of a motor vehicle according to the illustration in FIG. 2 with different arrangements of collision sensors.

### DETAILED DESCRIPTION OF THE DRAWINGS

Corresponding parts are provided with the same reference symbols in all figures.

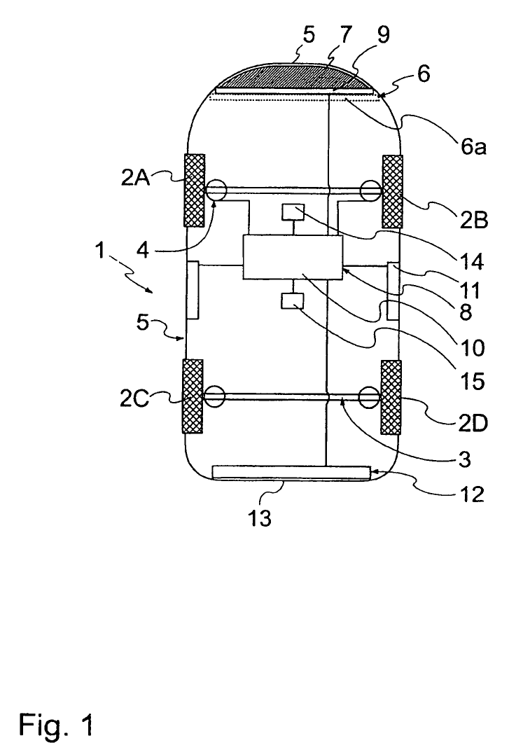

As shown in FIG. 1, an automobile 1 having vehicle or fender outer skin 5 is constructed on a chassis 3 which guides the vehicle wheels 2A, 2B, 2C, 2D. The outer skin is damped with respect to the chassis 3 by a suspension and damping device 4, as shown schematically in FIG. 1. The term vehicle outer skin is understood as meaning, in particular, the outer skin in the region of the longitudinal sides of the vehicle. The term fender outer skin is understood as meaning, in particular, the outer skin of a front or rear fender 7 in the front and/or rear region. The invention is explained in more detail below using the example of a head-on impact, so that the vehicle or fender outer skin 5 is referred to below as the fender outer skin 5 for short. In the front and/or rear region, the fender 7 is formed from the fender outer skin 5 and an impact absorber foam which is at least partially surrounded by the fender outer skin 5.

A crossmember 6a, which extends essentially over the width of the vehicle and is adjoined by the front fender 7 in the forward direction of travel, is shown schematically as the vehicle body part 6.

The automobile has a system 8 for detecting a collision of the motor vehicle 1. A collision sensor 9 which extends over the width of the motor vehicle 1 in the region of the front fender 7, represents a front sensor which is connected to an evaluation and control device 10. The evaluation and control device 10 is also connected to collision sensors 11, which are laterally arranged in doors (not illustrated in any further detail) of the motor vehicle 1 and are intended to detect a side impact, and to collision sensors 12 in the region of a rear fender 13 which are in the form of rear sensors and are intended to detect a rear-end impact. In this case, the collision sensors 11 and 12 extend along the width of the door and along the rear of the motor vehicle 1, respectively. Instead of a plurality of conventional individual selective sensors for one side of a vehicle, four elongate collision sensors 9, 12 and 11—one for the front region, one for the rear region and two for the longitudinal sides of the vehicle—are provided along the periphery of the vehicle in one development of the invention for the purpose of identifying an impact.

The evaluation and control device 10 drives safety means on the basis of the signals received from the collision sensors 9, 11, 12. A pedestrian protection device 14 and an active chassis regulating system 15, which interacts with the suspension and damping device 4, of said safety means, are shown schematically in the outline sketch of FIG. 1.

It is apparent that the evaluation and control device 10 may be connected to all safety and comfort systems which are present in a modern vehicle (for example, a vehicle surroundings detection device, which is known per se and can be implemented using sensor systems based on ultrasound technology, infrared technology, radar technology or else on image recognition) and to a wide variety of restraint systems, such as a seat adjustment device which conditions vehicle occupants and to an airbag controller.

In the present case, the symbolically shown pedestrian protection device 14 comprises means for actively raising the hood when a collision with a pedestrian is detected in order to create sufficient space between the hood and the engine so that an impact of the pedestrian on the hood can be cushioned.

The connection between the evaluation and control device 10 and the active chassis regulating system 15 is used to reduce further the risk of serious injury to a pedestrian, since it can be used to set the level of the hood to a height which is most favorable for the crash.

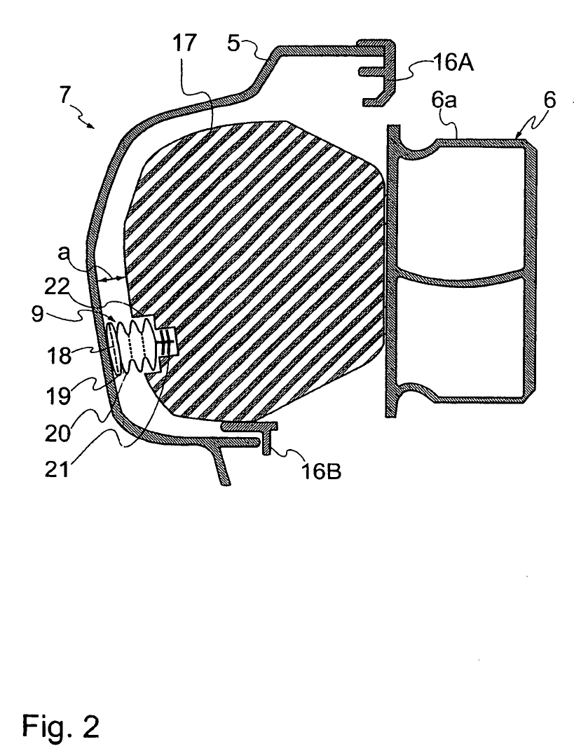

FIGS. 2 to 5 show different arrangements of one or more front, side and/or rear collision sensors 9, 11, 12 which are intended, for example, to detect a pedestrian collision, and which extend at least partially longitudinally and/or transversely over the associated side. The collision sensors 9, 11, 12 are respectively denoted in a simplified manner using the same reference symbol 9. The invention is explained in more detail for all subsequent designs using the example of the collision sensor 9 which is arranged on the front fender 7.

In all of the designs shown in FIGS. 2 to 5, the front fender 7 is fastened to the vehicle body part 6 (not shown in any more detail in FIGS. 2 to 5) in the region of the crossmember 6a using retention means 16A, 16B. A blocking element 17 comprising elastic material, foam or foam material in the present case, is respectively arranged in an interspace between the fender 7 and the crossmember 6a. The blocking element 17 forms the impact absorber of the fender 7.

In the refinement of the device according to the invention shown in FIG. 2, the collision sensor 9 is arranged between the crossmember 6a and the blocking element 17 which is arranged in the fender 7 and comprises foam or foam material.

The collision sensor 9 comprises a sensor element 18 which is arranged in a hollow profile 19, in particular in a hollow chamber, for protection from damage caused by mechanical and/or thermal loads. The sensor element 18 is in the form of a conventional contact sensor, pressure sensor, force sensor, acceleration sensor and/or deformation sensor. The sensor element 18 may also be in the form of a fiber-optic sensor.

Due to production and/or installation tolerances of, or initial damage to, the fender outer skin 5, the latter and the blocking element 17 are arranged at a distance from one another. In order to compensate for the distance a, the collision sensor 9 comprises a compressible spacer 20. To this end, the spacer 20 is, for example, in the form of an elastic rubber element or an elastic hollow profile, in particular can be compressed in the manner of an accordion or is similar to a bellows. Alternatively, the spacer 20 may be formed from a plurality of elastic chambers or cells, for example from a number of cells, in particular rubber cells (also referred to as air spring chambers). The latter are closed off with respect to one another, can be compressed and are provided with venting and/or ventilating openings. In this case, the venting and/or ventilating openings determine the elastic property of the chamber or cell.

In order to at least partially arrange the collision sensor 9 in the blocking element 17, a dimensionally stable solid profile 21 in the form of a fastening foot is also provided on the side of the spacer 20 which is remote from the sensor. The solid profile 21 is, for example, in the form of a clamping element, latching element, clip element, snap-on element and/or sealing element. To this end, the solid profile 21 has a fir tree shape in longitudinal section, thus retaining the collision sensor 9 in the blocking element 17 in a step-like manner. Such an embodiment of the solid profile 21 makes it possible to install the collision sensor 9 in the blocking element 17, and to remove it from the latter, without destroying it.

For example, the collision sensor 9 is fastened by clipping or pressing the fastening foot, which is in the form of a “fir tree profile”, into an appropriately shaped and elongate groove of the blocking element 17. In this case, during installation, the fastening foot or solid profile 21 is used to press or clip the collision sensor 9 into the groove of the blocking element 17 beginning from one end of the rubber band or the rubber profile element. For removal, the rubber band is levered or pulled out of the groove from one end, so that the collision sensor 9 is removed from the blocking element 17 or is replaced without being destroyed.

In order to hold the solid profile 21, which is in the form of a fastening foot, in the blocking element 17, the latter comprises a step-like recess 22, for example. Depending on the type, shape and number of collision sensors 9 to be held, the recess 22 may also be in the form of a groove in the blocking element 17 or in the form of an individual recess for an individual collision sensor 9. In this case, the recess 22 has a diameter which decreases in a stepwise manner and outer dimensions which decrease. As a result, the fastening foot is retained in a recess that is smaller than the recess for the spacer 20.

The collision sensor 9 is preferably formed in one piece. To this end, the hollow profile 19, the spacer 20 and the solid profile 21 are formed from a profile element, such as rubber. The various functions of protective sheath for the hollow profile 19, compressibility of the spacer 20 and fastening foot of the solid profile 21 can be established using an appropriate shape, size and thickness of the elastic material, for example rubber. For example, the one-piece rubber profile element correspondingly has different rubber curing zones in order to form the functional zones. The collision sensor 9 may also be produced from individual separate elements having different material hardnesses.

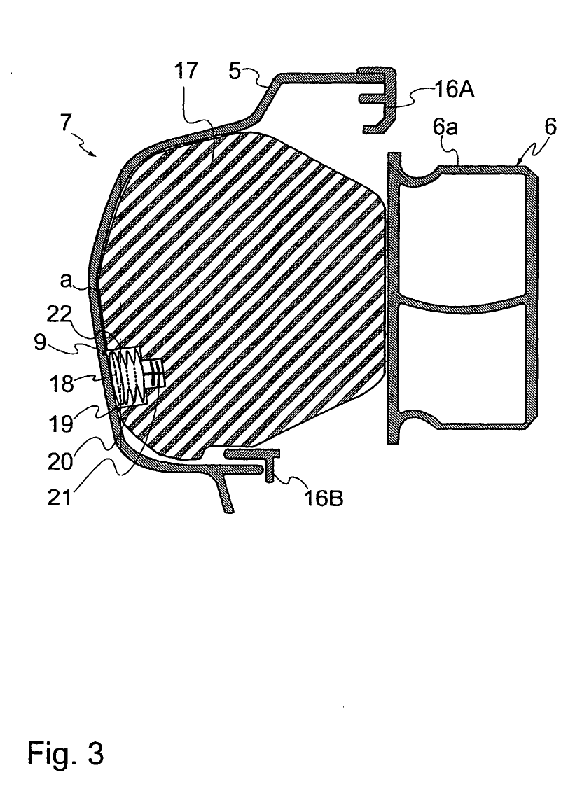

In comparison with FIG. 3, there is a larger distance a between the vehicle or fender outer skin 5 and the blocking element 17 in FIG. 2. As a result the compressible spacer 20 in FIG. 2 has an extended shape, which runs essentially longitudinally to the direction of impact, and projects beyond the recess 22 of the blocking element 17. In contrast, there is a small distance a in FIG. 3, so that the spacer 20 is compressed and is essentially arranged in the recess 22 of the blocking element 17.

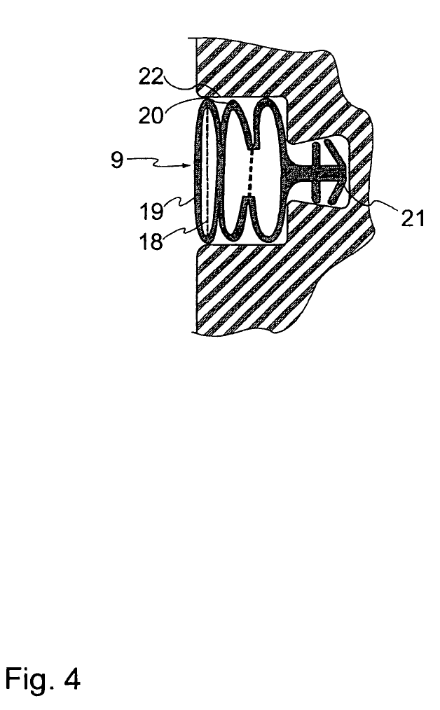

FIG. 4 shows an enlarged detail of FIG. 2 in the region of the recess 22 with the collision sensor 9. The recess 22 for assisting a connection which can be latched or clipped may be in the form of a hollow cylinder or a truncated pyramid (dashed illustration) in the region of the fastening foot of the collision sensor 9. The design of the fastening foot in the form of a dimensionally stable solid profile and the design of the compressible spacer 20 in the form of a bellows-like hollow profile are illustrated in detail in FIG. 4. The contact sensor 18 is arranged in the hollow profile 19 in the manner of a hollow chamber.

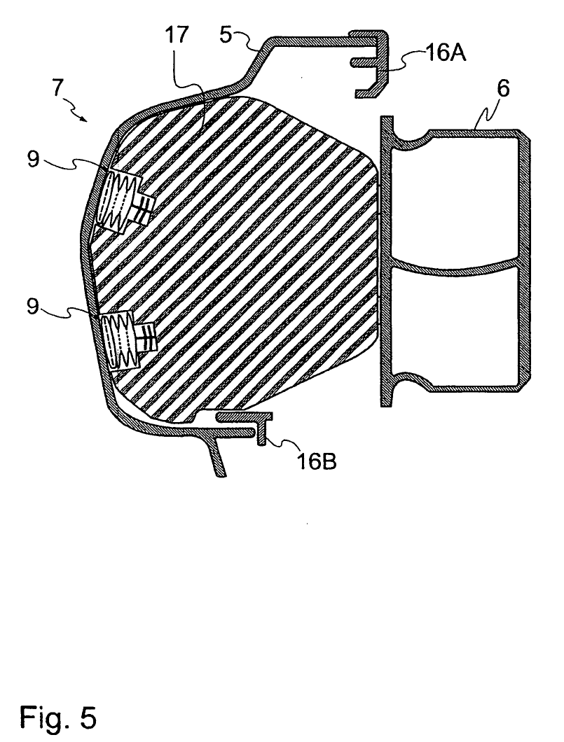

Furthermore, according to a design shown in FIG. 5, it is possible for a plurality of collision sensors 9 to be arranged between the inside of the fender 7 or the inside of the vehicle or fender outer skin 5 and the foam or foam material blocking element 17 arranged in the fender 7.

The collision sensors 9 may also be arranged on and/or in the foam or foam material blocking element 17.

The possible ways of fitting the collision sensors 9 which are shown all relate to the front fender 7 shown. However, it goes without saying that the rear sensors 12 may also be arranged in an analogous manner when the rear fender 13 is configured in a comparable manner.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1.-17. (canceled)

18. A device for detecting a collision of a motor vehicle, said device comprising:
at least one collision sensor arranged between a vehicle or fender outer skin and a vehicle body part, for sensing an impact of an object on the motor vehicle;
wherein the collision sensor comprises a compressible spacer which presses the collision sensor against the outer skin which absorbs the collision.

19. The device as claimed in claim 18, wherein the spacer comprises an elastic rubber element.

20. The device as claimed in claim 18, wherein the spacer comprises a hollow profile which can be compressed in the manner of an accordion.

21. The device as claimed in claim 18, wherein the spacer comprises a plurality of cells; and
said cells are closed off with respect to one another, can be compressed and are provided with venting or ventilating openings.

22. The device according to claim 21, wherein said cells are rubber cells.

23. The device as claimed in claim 18, wherein a substantially dimensionally stable solid profile is provided on a side of the spacer which is remote from the sensor.

24. The device as claimed in claim 23, wherein the solid profile comprises one of a clamping element, a latching element, a clip element, a snap-on element and a sealing element for retaining the collision sensor.

25. The device as claimed in claim 24, wherein the solid profile has an accordion shape.

26. The device as claimed in claim 18, wherein the collision sensor comprises a sensor element arranged in a hollow profile.

27. The device as claimed in claim 26, wherein the hollow profile, the spacer and the solid profile are formed as one of a piece, and separate elements.

28. The device according to claim 27, wherein the spacer and the solid profile comprise a one-piece rubber profile.

29. The device as claimed in claim 27, wherein the one-piece rubber profile element has a plurality of different rubber curing zones.

30. The device as claimed in claim 18, wherein the collision sensor comprises, one of a contact sensor, an acceleration sensor, a force sensor, a fiber-optic sensor and a deformation sensor.

31. The device as claimed in claim 18, wherein one of the following is true:
the collision sensor extends longitudinally to the vehicle or fender outer skin. at least in regions; and
the collision sensor extends entirely over the width of the vehicle or length of the vehicle.

32. The device as claimed in claim 18, wherein the collision sensor is a front sensor, arranged in an area of a fender of the motor vehicle.

33. The device as claimed in claim 32, wherein the collision sensor is arranged between the fender outer skin and a blocking element which is arranged in the fender and comprises an elastic material.

34. The device according to claim 33, wherein the collision sensor comprises a foam material.

35. The device as claimed in claim 33, wherein the sensor element of the collision sensor is arranged on a side of the blocking element which faces a fender outer skin.

36. The device as claimed in claim 33, wherein the solid profile retains the collision sensor on, or at least partially in, the blocking element comprising elastic material.

37. The device as claimed in claim 33, wherein the solid profile is retained in a groove of the blocking element.
